(19) United States
(12) Patent Application Publication
(10) Pub. No.: US 2003/0001905 A1
(43) Pub. Date: Jan. 2, 2003

(54) Medical analysis device

(76) Inventors: Geert Richard Kemkers, Fairfield, CT (US); Rudolf Theodoor Suurmond, Eindhoven (NL)

Correspondence Address: Philips Medical Systems, 595 Miner Road, Clevland, OH, 44143, US

(21) Appl. No.: 10/181,650

(22) PCT Filed: Nov. 15, 2001
(86) PCT No.: PCT/EP01/13324

(30) Foreign Application Priority Data
Nov. 20, 2000 (EP) 00204102.8

(51) Int. Cl. G09G 5/00

(52) U.S. Cl. 345/848

(57) ABSTRACT

The invention relates to a medical analysis device which is intended to analyze a three-dimensional image acquired by means of angiography or radiography. The device includes a memory in which the three-dimensional image is stored. The image is displayed on a monitor. The system includes a manipulator which is intended to process voxels of the image. The manipulator notably deletes or erases voxels selectively from the three-dimensional image in a predetermined direction. Such a manipulator operates as an electronic eraser.

The invention relates to a medical analysis device for a three-dimensional image acquired by means of, for example angiography or radiography, which device includes a storage member for storing voxels that together constitute the image, a display device for displaying the image, and a manipulating member for manipulating the imaging voxels.

A device of this kind is marketed by applicant and is used, for example in hospitals, for the evaluation of images of patients that have been acquired by means of angiography or radiography. An example of such an application is the evaluation of a blood vessel structure so as to determine whether and to what extent a medical intervention is desirable.

One function that is desirable for such a medical evaluation concerns the possibility of determining the volume of the parts of the body examined.

Another function that is desirable for such a medical analysis device concerns the possibility of further analysis of regions of the part of the body of the patient that is involved in the examination, that is, to use the analysis device to exclude, erase or measure such regions from or in images obtained by means of the medical analysis device.

Another function concerns the possibility of evaluation from different sides of the body part that has been imaged, or the possibility of making cross-sections thereof at angles that can be determined at random.

The present invention aims to facilitate these and other functions of such a medical analysis device.

To this end, in accordance with a first aspect of the invention the medical analysis device is characterized in that the manipulating member is arranged for the selective erasure of voxels in a predetermined direction. A selection can thus be performed on the image material obtained, thus enabling the extraction of relevant data therefrom; such an operation is performed completely under the control of a medical expert operating the analysis device.

For suitable control and transparency of the operation of the medical analysis device it is desirable that the predetermined direction then extends perpendicularly to the image plane of the display device.

Very accurate detailing and selection of the image material that is desired or not benefit from the fact that the voxels to be erased in the predetermined direction are situated one in the prolongation of the other.

In order to optimize the management and control of the image material, the medical analysis device is preferably constructed in such a manner that the voxels to be erased in a predetermined direction are erasable over an adjustable distance. Evidently, when erasure has been carried out too far in a given direction, the erased material can be restored again in au inverse operation, without it being necessary to perform all previously performed manipulations again on the original image material. This benefits in particular the ease of operation and use of the device in accordance with the invention.

In accordance with a further aspect of the invention, where the analysis device is provided with a manipulating member that is arranged to adjust the orientation of an imaginary cutting plane that serves to cut through the image formed by the voxels and where the display device is capable of simultaneous display of the cutting plane and at least part of the image formed by the voxels, is characterized in that an imaginary point of origin that is situated in the cutting plane can be allocated to the cutting plane and that this point constitutes a point of rotation for the cutting plane when the orientation of the cutting plane is readjusted.

This facility represents an important improvement over the prior art medical analysis device in which the cutting plane, upon readjustment, moves around a point of origin that is situated at the center of the image relative to the part of the body being examined. This gives rise to unnatural and comparatively complex positioning of the cutting plane in the image and hence of the cross-section through the organ of the patient being examined. The analysis of the part of the body or organ being examined according to prior art is thus seriously hampered.

This problem is eliminated by providing the medical analysis device in accordance with the invention with the facility that has just been introduced. When the point of origin about which the cutting plane can move is positioned such that it is situated in the cutting plane, the movement of the cutting plane becomes very natural; this significantly facilitates the analysis of the part of the body or organ being examined.

It is to be noted that U.S. Pat. No. 4,984,157 discloses a system for adjustment and rotation of cutting planes through a three-dimensional body as represented by the voxels that are stored in a storage member; therein the cutting plane is moved relative to an arbitrary origin selected from the image space. The solution in accordance with the invention, that is, situating the point of origin in the cutting plane itself instead of in an arbitrary position, however, is not known from the cited publication.

In order to offer the person operating the medical analysis device in accordance with the invention more freedom of choice and possibilities for examnination, it is advantageous when the manipulating member is arranged to adjust the imaginary point of origin.

A suitable and at the same time very simple method of realizing the foregoing is characterized in that the manipulating member is a mouse which is provided with a mouse cursor and a mouse button, and that the mouse button can be used to adjust the imaginary point of origin of the cutting plane and the mouse cursor can be used to adjust the orientation of the cutting plane. It is also possible to use a track ball or another suitable adjusting member for this purpose.

An alternative embodiment of the medical analysis device in accordance with the invention is characterized in that the device positions the imaginary point of origin at the center of gravity of the cutting plane. This saves an operation for adjustment by the user of the analysis device, thus simplifying the device while at the same time imparting a reproducible position to the point of rotation of the cutting plane.

In a further elaboration of this application it may be advantageous that, when the cutting plane is readjusted, the device adapts the imaginary point of origin and keeps it positioned in the shifting center of gravity of the cutting plane. The determination of the center of gravity is based each time on the cutting plane as it is visible to the user in the image displayed by the display device.

In a further preferred embodiment of the analysis device in accordance with the invention the imaginary point of origin may (at the same time) form a point of rotation for the image displayed by the display device.

The invention also relates to methods of processing a three-dimensional image. Methods in accordance with the invention are defined in the claims 11 and 13. The invention also relates to computer programs for the processing of a three-dimensional image. Computer programs in accordance with the invention are defined in the claims 12 and 14.

It is assumed that the above description is complete and clear to such an extent that a person skilled in the art can readily carry out the invention without requiring further information.

1. A medical analysis device for a three-dimensional image acquired by means of, for example angiography or radiography, which device includes a storage member for storing voxels that together constitute the image, a display device for displaying the image, and a manipulating member for manipulating the imaging voxels, characterized in that the manipulating member is arranged for the selective erasure of voxels in a predetermined direction.

2. A medical analysis device as claimed in claim 1, characterized in that the predetermined direction extends perpendicularly to the image plane of the display device.

3. A medical analysis device as claimed in claim 1 or 2, characterized in that the voxels to be erased in the predetermined direction are situated one in the prolongation of the other.

4. A medical analysis device as claimed in one of the claims 1 to 3, characterized in that the voxels to be erased in the predetermined direction are erasable over an adjustable distance.

5. A medical analysis device for a three-dimensional image acquired by means of, for example, angiography or radiography, which device includes a storage member for storing voxels that together constitute the image, a display device for displaying the image, and a manipulating member for manipulating the imaging voxels, which manipulating member is arranged to adjust the orientation of an imaginary cutting plane that serves to cut through the image formed by the voxels, the display device being capable of simultaneous display of the cutting plane and at least part of the image formed by the voxels, characterized in that an imaginary point of origin that is situated in the cutting plane can be allocated to the cutting plane and that this point constitutes a point of rotation for this cutting plane when the orientation of this cutting plane is readjusted.

6. A medical analysis device as claimed in claim 5, characterized in that the manipulating member is arranged to adjust the imaginary point of origin.

7. A medical analysis device as claimed in the claims 5 and 6, characterized in that the manipulating member is a mouse which is provided with a mouse cursor and a mouse button, and that the mouse button can be used to adjust the imaginary point of origin of the cutting plane and the mouse cursor can be used to adjust the orientation of the cutting plane.

8. A medical analysis device as claimed in claim 5, characterized in that the device positions the imaginary point of origin at the center of gravity of the cutting plane.

9. A medical analysis device as claimed in one of the claims 5 to 8, characterized in that when the cutting plane is readjusted, the device adapts the imaginary point of origin and keeps it positioned at the shifting center of gravity of the cutting plane.

10. A medical analysis device as claimed in one of the claims 5 to 9, characterized in that the imaginary point of origin constitutes a point of rotation for the image.

11. A method of processing and displaying a three-dimensional image acquired by means of, for example, angiography or radiography and comprising voxels that together constitute the image, characterized in that voxels are selectively erased in a predetermined direction.

12. A computer program with instructions for the processing and display of an image acquired by means of, for example, angiography or radiography and comprising voxels that together constitute the image, characterized in that voxels are selectively erased in a predetermined direction.

13. A method of processing a three-dimensional image acquired by means of, for example, angiography or radiography and comprising voxels that together constitute the image, where the image is displayed and the orientation is adjusted of an imaginary cutting plane that serves to cut through the image formed by the voxels, the cutting plane and at least part of the image formed by the voxels being displayed simultaneously, characterized in that an imaginary point of origin that is situated in the cutting plane is allocated to the cutting plane and that this point constitutes a point of rotation for this cutting plane when the orientation of this cutting plane is readjusted.

14. A computer program with instructions for the processing of a three-dimensional image acquired by means of, for example, angiography or radiography and comprising voxels that together constitute the image, where the image is displayed and the orientation is adjusted of an imaginary cutting plane that serves to cut through the image formed by the voxels, the cutting plane and at least a part of the image formed by the voxels being displayed simultaneously, characterized in that an imaginary point of origin that is situated in the cutting plane is allocated to the cutting plane and that this point constitutes a point of rotation for this cutting plane when the orientation of the cutting plane is readjusted.
